(19) United States
(12) Patent Application Publication
(10) Pub. No.: US 2026/0147342 A1
(43) Pub. Date: May 28, 2026

(54) Tele-Operation System with Low Bandwidth

(71) Applicant: HDT Expeditionary Systems, Inc., Solon, OH (US)

(72) Inventors: Kent Massey, Bryn Mawr, PA (US); Thomas Van Doren, Fredericksburg, VA (US)

(73) Assignee: HDT Expeditionary Systems, Inc., Solon, OH (US)

(21) Appl. No.: 19/397,350

(22) Filed: Nov. 21, 2025

Related U.S. Application Data
(60) Provisional application No. 63/724,021, filed on Nov. 22, 2024.

(51) Int. Cl. G05D 1/224; G05D 1/226; G05D 107/13; G05D 109/10; G05D 111/10; G05D 111/30; G06T 17/20

(52) U.S. Cl. CPC G05D 1/2247; G05D 1/226; G06T 17/20; G05D 2107/13; G05D 2109/10; G05D 2111/10; G05D 2111/30

(57) ABSTRACT

A method for tele-operation includes sensing image data of a remote environment using one or more sensors provided on remote equipment; creating a simplified computer model of the remote environment by image processing carried out on the remote equipment; and transmitting the simplified computer model to a remote operator and displaying the simplified computer model to the remote operator. A system or apparatus includes at least one sensor disposed on a portion of an associated remote vehicle, the at least one sensor configured to measure a corresponding parameter related to the associated remote vehicle; and an operator control system configured to receive the measured corresponding parameter as a binary data stream of the associated remote vehicle, the binary data stream can be on the order of hundreds of bits.

### CROSS-REFERENCE TO RELATED APPLICATION

This application claims priority from and benefit of the filing date of U.S. provisional application Ser. No. 63/724,021 filed Nov. 22, 2024, and the entire disclosure of said provisional application is hereby expressly incorporated by reference.

### BACKGROUND

Tele-operation systems are used to remotely operate equipment, especially unmanned vehicles, by providing a remote operator with a visual depiction of the environment within which the equipment is operating. In existing systems, this visual depiction was accomplished using video, sometimes accompanied by audio, which is transmitted from the remote environment. The audio/video sensors and transmitter are generally mounted on the remote equipment.

The key performance requirement for a tele-operation system is to provide the remote operator with a sufficiently accurate spatial understanding of the equipment in its environment so that the operator can safely and efficiently control the equipment to perform a task. Current tele-operation systems include features to: optimize the location and type of sensors; control the pointing of these sensors; process audio/video data on the remote equipment; compress the audio/video signal; transmit the audio/video to the operator; decompress the audio/video; and present the audio/video data to the operator.

Current tele-operation systems can use live image data transmitted from the remote equipment. The image data can be from a video camera, thermal imager, or some other sensor, such as a point-cloud from a LIDAR.

All these sensors require significant bandwidth to transmit their image data, even if the image data is highly compressed. As used herein, “bandwidth” means the data channel usage of a wireless or wired connection such as a radio signal or fiber optic connection.

Radios are often used to transmit this image data, especially for remote equipment that is mobile, such as unmanned vehicles. Radio transmission of high-bandwidth video signals is problematic for many reasons. As a result of difficulties with radio transmission, the operating range between the operator and the remote equipment can be very limited. In addition, the quality of the video signal can be greatly reduced, and the transmission latency can be greatly increased—both of which impairs safety and productivity of remote operations.

### SUMMARY OF THE INVENTION

The present disclosure combines techniques including image recognition, photogrammetry, and simultaneous localization and mapping to create a simplified computer model of the remote environment, which can be efficiently transmitted and displayed to the remote operator.

Objects in the remote environment are categorized and recognized using image processing. The type of object is encoded based on an onboard library of object types, such as tree, building, automobile, etc. For each object, a subtype is also assigned, if available, as well as its size, geolocation, color, texture, and subcomponent details. Each object is also given a unique sequence number for tracking.

For example, “Object 000004382” might be a coniferous tree with specific dimensions, geospatial location, a shade of green, needle type, needle density, trunk diameter, and clear height between the ground and lower branches. All this information can be encoded in only a few bytes of data.

Once transmitted from the remote equipment to the remote operator's control unit, only updates need to be transmitted. For instance, if the object is an automobile in motion, the location and pose (i.e., orientation) of the automobile will be continuously updated until it is no longer in sight. The dimensions, color, and type of automobile, however, will only be sent once—unless those initial details are later determined to be in error by the vehicle's onboard image processing and need to be updated.

The terrain around the remote equipment is sensed using techniques related to photogrammetry and simultaneous localization and mapping, so that a surface mesh can be calculated that represents the ground. Color and/or texture can be applied to this mesh, using techniques related to computer games.

If existing information about the terrain is stored on the remote equipment, this data can be used to fill in blind spots in the sensor data. Any discrepancies between existing information and sensor data can be identified to the remote operator.

If the remote equipment is using some level of autonomy to move within the remote environment, the future path of that movement can be sent to the remote operator and displayed on the remote operator's control unit. The remote operator can modify or cancel the intended autonomous movement and that control information is sent back to the remote equipment.

The location and pose of the remote equipment that is being controlled is continuously tracked and sent the remote operator's control unit. Terrain and objects in the remote environment are displayed to the remote operator. If existing information about the terrain is stored on the remote operator's control unit, this data can be used to fill in blind spots in the sensor data. Any discrepancies between existing information and sensor data can be identified to the remote operator.

The viewing angle and perspective that is displayed can be controlled by the remote operator. Typically, an “over the shoulder” perspective supplies the best viewing angle. For remote operations of a manipulator arm, close-up views of the end-effector's working area might be used. For control of an unmanned vehicle, a “bird's eye” view that is similar to a computer racing game might be used.

There are inevitable delays (latency) involved in processing, transmitting, and displaying a depiction of the environment to remote operators. This latency can be estimated and the depiction of the environment to the operator can be adjusted forward in time to compensate for the latency.

For instance, if the tele-operation is to control an unmanned vehicle moving at five meters per second and there is an estimated 100 milliseconds of latency, then the position of the unmanned vehicle can be adjusted a half meter forward along the vehicle's predicted path in the video image displayed to the operator.

The present disclosure, as described, will provide much lower bandwidth tele-operational control of remote equipment, with improvements in situational awareness due to selectable views and reductions in latency effects due to both more efficient data transmission as well as compensation for latency in the displayed image.

In some alternatives, a method for tele-operation includes sensing image data of a remote environment using one or more sensors provided on remote equipment; creating a simplified computer model of the remote environment by image processing carried out on the remote equipment; and transmitting the simplified computer model to a remote operator and displaying the simplified computer model to the remote operator.

In some alternatives, a system or apparatus includes at least one sensor disposed on a portion of an associated remote vehicle, the at least one sensor configured to measure a corresponding parameter related to the associated remote vehicle; and an operator control system configured to receive the measured corresponding parameter as a binary data stream of the associated remote vehicle, the binary data stream can be on an order of hundreds of bits.

### BRIEF DESCRIPTION OF THE DRAWINGS

FIGS. 1A and 1B are illustrations of how object recognition can be used to identify trees in a remote location and then information about each tree's species, size, geolocation, color, and texture can be transmitted to create a display for the remote operator.

FIG. 2 is a flow chart showing how an object can be identified and described in a compact format, which is then transmitted to create a display for the remote operator.

FIGS. 3A and 3B are illustrations of how photogrammetry can be used to generate a terrain mesh for a remote location.

FIG. 4 shows how the orientation and movement of remotely operated equipment, such as a vehicle, can be described.

FIG. 5 illustrates how the display of the remote environment can be updated over time to represent movement of remote equipment.

FIGS. 6A and 6B show how moving objects can be represented.

FIG. 7 illustrates how the same scene can be shown in different views.

FIG. 8 shows an operator display of a remotely operated vehicle can combine directly observed terrain with terrain information from other sources to fill in areas that cannot be directly observed.

FIGS. 9A and 9B show how the operator can adjust the intended autonomous path of a remotely operated vehicle.

FIGS. 10A and 10B show how the system can compensate for transmission latency.

FIG. 11 shows the system including one or more sensors disposed on a remote vehicle in communication with a remote operator control station.

### DETAILED DESCRIPTION

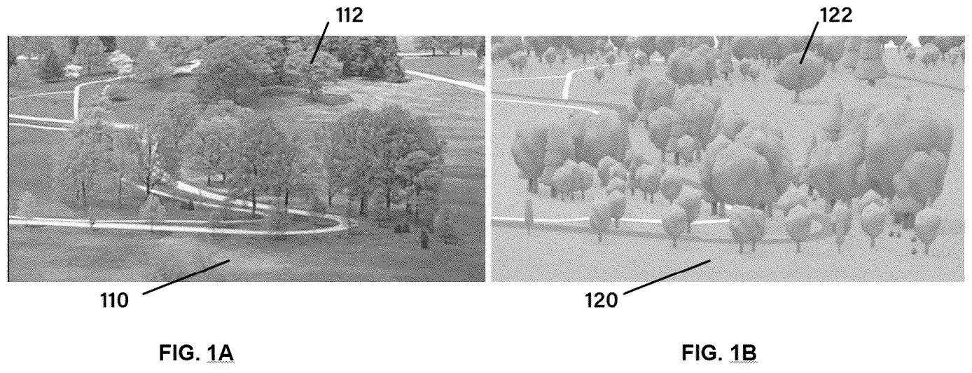

FIGS. 1A and 1B illustrate an output of representing objects within an image such as a video frame (FIG. 1A) of a remote scene 110, as sensed by one or more sensors mounted on remote equipment such as a manned or unmanned vehicle (not shown in FIGS. 1A and 1B), by processing into compressed data that is transmitted to a location remote from the equipment located at the remote scene 110 and that compressed data is then rendered into a computer display of the remote objects for an operator in a video frame 120 (FIG. 1B). The original image shown in FIG. 1A can be derived from one or more sensors (not shown in FIGS. 1A and 1B) mounted on the remote equipment such as at least one video camera, at least one thermal imager, or at least one other sensor, such as a point-cloud LIDAR sensor.

Objects in the remote environment are categorized and recognized using image processing that can be performed on a processor that is part of the remote equipment. The image processing performed on the remote equipment can comprise image recognition, photogrammetry, and simultaneous localization and mapping to create a simplified computer model shown in FIG. 1B of the remote environment shown in FIG. 1A, so that the simplified computer model shown in FIG. 1B can be efficiently transmitted and displayed to the remote operator on a computer display which can be a mobile computer device, a wearable computer device (i.e., goggles, glasses or similar virtual or augmented reality device), or any other computer device. The remote operator can then view the model shown in FIG. 1B and send wireless radio signal control commands to the remote equipment to alter the movement path and/or otherwise control the remote equipment. For objects represented in the image A, the type of object is encoded based on an onboard library of object types stored in memory on the remote equipment, wherein the library includes common object types such as tree, building, automobile, car, tank, person, etc. For each object, a subtype stored in the library is also assigned, if available, as well as its size, geolocation as determined by geolocation equipment carried by the remote equipment, color, texture, and subcomponent details.

Each object is also given a unique sequence number for tracking. In the illustrated example, a tree 112 of the video image frame shown in FIG. 1A is analyzed through object-recognition algorithms and categorized as a tree object 122 (as shown in the model shown in FIG. 1B), for example, by species, size, geolocation, color, and texture. This tree 112 is assigned a unique identifier, such as Object 000004382. Data associated with this object 122 added to the generated simplified computer model B and is transmitted a single time by wireless radio transmission to the remote operator's control unit, where tree object 122 is stored and displayed in the correct geolocation whenever the actual tree 112 corresponding to the tree object 122 is within the view displayed to the remote operator.

If the actual tree 112 changes in some meaningful way as sensed by the remote equipment camera(s)/sensor(s), such as falling down for example, or is seen in greater detail by sensors on the remote equipment that meaningfully change some part of its categorization, then such updated information is sent to the remote operator's control unit for Object 000004382, as an example, and the display of the tree object 122 in the computer model shown in FIG. 1B is revised to incorporate this updated information. Otherwise, if the tree 112 is unchanged, data about the associated tree object 122 is not changed in the model shown in FIG. 1B and is not re-transmitted to the remote operator's control unit for “Object 000004382”.

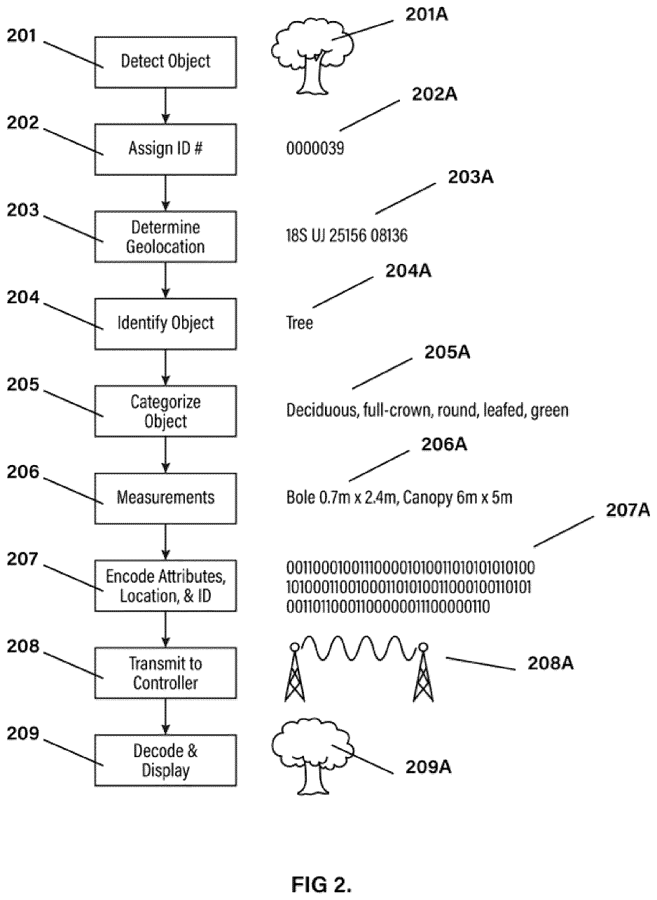

FIG. 2 shows a flowchart showing operations involved in recognizing, processing, transmitting, and displaying an object. Operation 201 represents the detection of a new object, such as a tree 201A, by one or more sensors mounted on remote equipment, such as a manned or unmanned vehicle. In operation 202, this new object is assigned a unique identifier 202A, such as “0000039”. In operation 203, a geolocation 203A of the tree 201A is determined by knowing the geolocation of the remote equipment and measuring the range and bearing from the remote equipment to the tree 201A. This measurement can be made using methods such as LIDAR, stereo imaging, or other methods. In FIG. 2, the geolocation 203A “18S UJ 25156 08136” in the Military Grid Reference System (MGRS) coordinates for locating the tree 201A with centimeter-level accuracy.

In operation 204, the new object is identified 204A as a “tree” through object-recognition algorithms. In operation 205, the tree 201A is further categorized and assigned attributes using object-recognition algorithms and a library of preassigned object subcategories and attributes 205A, such as “Deciduous, full-crown, round, leafed, green”. The library can use, for example, three digit codes for object category and subcategory, and two digit codes for attributes, or any other system of unique identifiers. In operation 206, key dimensions of the tree 201A are estimated, such as its bole (i.e., trunk diameter), a height of the trunk from the ground to the lower limbs of the canopy, width of the canopy, and height of the canopy. For example, dimensions 206A can be “Bole 0.7 m×2.4 m, Canopy 6 m×5 m”.

In operation 207, all the information needed to represent this object (i.e., the tree) is encoded into binary data, including the unique identifier 202A, the geolocation 203A, the object category 204A, the object subcategory and attributes 205A, and the dimensions 206A. The maximum size of binary data 207A is about 200 bits, on the order of hundreds of bits, which only needs to be sent to the remote operator's control unit a single time. In comparison, a video image of tree 201A would require many thousands of bits, and a new video image of tree 201A would need to be sent either 30 or 60 times per second, depending on the video frame rate. If tree 201A is visible on the operator's display for a minute, the reduction in transmission bandwidth is on the order of 100,000 to 1, advantageously reducing the amount of bandwidth needed to transmit data. It should be noted that, as used herein, the term “bandwidth” is not limited to wireless radio signals but can also include signals transmitted over a fiber optic cable or other cable and is intended to mean data channel usage of any such wireless or wired connection.

In operation 208, the binary data 207A is sent from the remote equipment to the remote operator's control unit using, for example, the radio link 208A. Other communications links are possible, such as orbiting satellites, fiber optics, and free-space lasers. Finally, in operation 209, the binary data 207A for tree 201A. The display of tree 209A will not exactly match the actual tree 201A, but the representation of the tree will be sufficient for remote operations in environments where adequate communications bandwidth is not available for full-motion video.

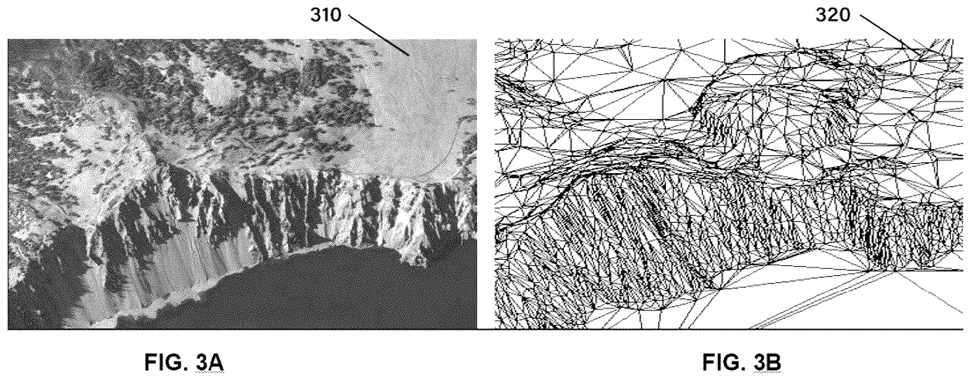

FIGS. 3A and 3B illustrate the conversion of terrain topology as sensed by sensors on the remote equipment in scene 310 (FIG. 3A) into a mathematical mesh B of polygons representing that terrain topology, as shown by the data 320 (FIG. 3B) using methods such as a Simultaneous Localization And Mapping (SLAM) process, photogrammetry, and other related methods. The simplification of the terrain mesh 320 results in producing data streams in manageable sizes for data transmission.

SLAM and photogrammetry techniques are also capable of recognizing color and texture of the terrain. All this terrain mesh 320 information is transmitted a single time to the remote operator's control unit, where terrain mesh 320 is stored as part of the model B and displayed to the remote operator.

As the remote equipment moves through the actual real-world terrain 310, the terrain mesh model 320 is extended and updated. This additional information is transmitted to the remote operator's control unit, where terrain mesh 320 is extended and updated for display to the operator as part of the model shown in FIG. 3B.

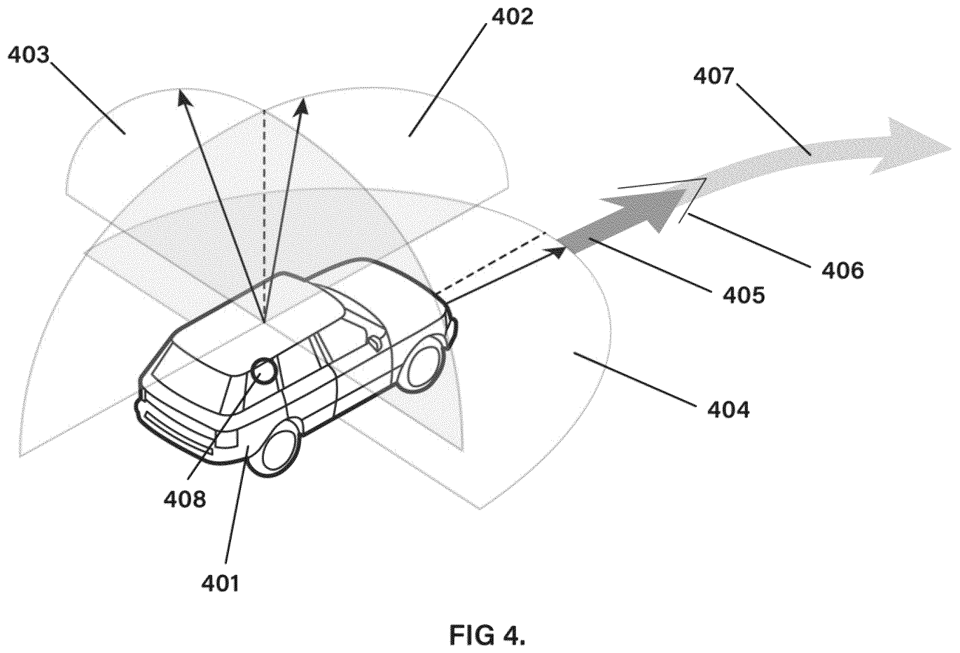

FIG. 4 shows how information about the remote equipment, such as a vehicle 401, can be gathered for transmission to the remote operator's control unit. A pitch angle 402 of the vehicle 401 and a roll angle 403 of the vehicle 401 can be measured by an Inertia Measurement Unit (IMU), such as an inexpensive Micro Electromechanical System (MEMS) gyroscope. A heading angle 404 of the vehicle 401 can also be measured by a MEMS IMU, although a more precise gyroscope, such as a Fiber Optic Gyroscope (FOG), will provide more accurate results. The combination of the vehicle's pitch, roll, and heading is referred to as its “pose.”

A speed 405 of the vehicle 401 can be measured by a speedometer, Global Positioning Satellite (GPS), or other means. An acceleration 406 in all three axes of the vehicle 401 can be measured by an IMU. An expected trajectory 407 of the vehicle 401 can be estimated by a combination of the speed 405, the acceleration 406, and commands received from the remote operator for changes in steering and speed. If the vehicle 401 is operating autonomously or semi-autonomously, a trajectory 407 of the vehicle 401 can be a mathematical description of the autonomy system's intended path for the vehicle 401.

A geolocation 408 of the vehicle 401 can be determined by many different means, including GPS and other global navigation satellite systems. In areas where satellite navigation is not available, dead reckoning techniques to measure the geolocation 408 of the vehicle 401 is possible using an IMU. Other techniques, such as triangulation from known landmarks, are also possible.

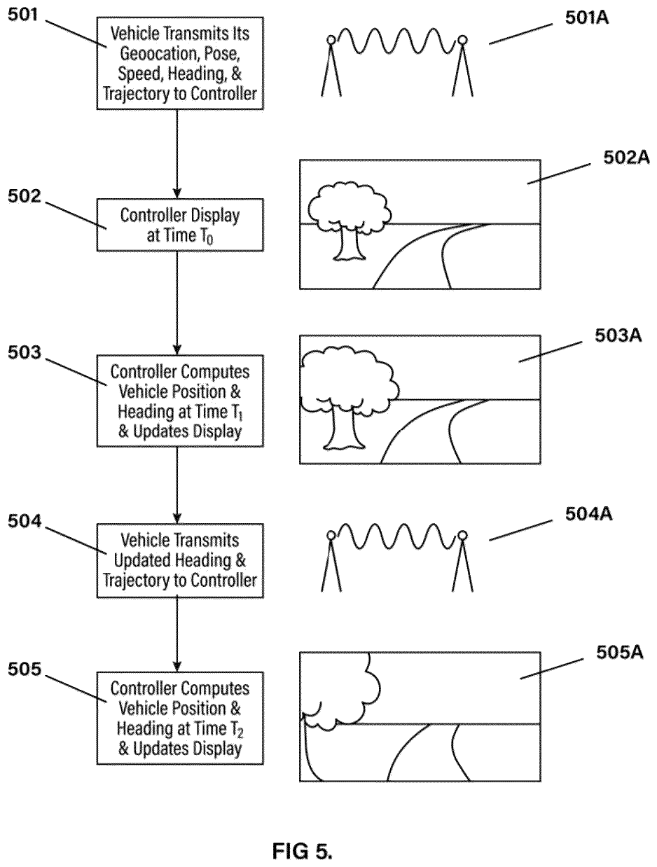

FIG. 5 shows a flow chart depicting how the remote operator's video display advances forward in time with minimal input needed from the remote equipment, which in this example is a remote vehicle. Operation 501 shows a radio transmission 501A of data containing the remote vehicle's geolocation, pose, speed, heading, and trajectory.

Operation 502 illustrates a display 502A of the remote operator showing the remote environment from the perspective of the remote vehicle's ‘driver's view’. This view synthesizes the data previously sent from the remote vehicle about the terrain and objects in the terrain, along with the data in the radio transmission 501A. The view represents what a driver in the vehicle would see looking forward, from the location and with the orientation of the remote vehicle, at time (T₀).

Operation 503, at a later time (T₁), shows an updated driver's view 503A of the remote operator's display, based on how far the remote vehicle has advanced in the remote environment, given the remote vehicle's speed, heading, and trajectory in the radio transmission 501A. In this example, the remote vehicle's speed, heading, and trajectory has not changed, so no further transmission from the remote vehicle was necessary to generate an accurate remote operator's display 503A. However, a position of a tree relative to the remote vehicle's updated position has changed (e.g., the tree is now closer to the remote vehicle), and the updated driver's view 503A shows this change relative to the display 502A.

Operation 504 depicts how a change in the remote vehicle's heading and trajectory, such as a turn to the left in this example, is sent in a radio transmission 504A to the remote operator's control unit. Operation 505 shows how the updated data from the radio transmission 504A is used to generate the remote operator's display 505A depicting the remote vehicle's turn to the left. This is reflected in the position of the tree and the road relative to the position of the remote vehicle in the display 505A relative to the display 503A.

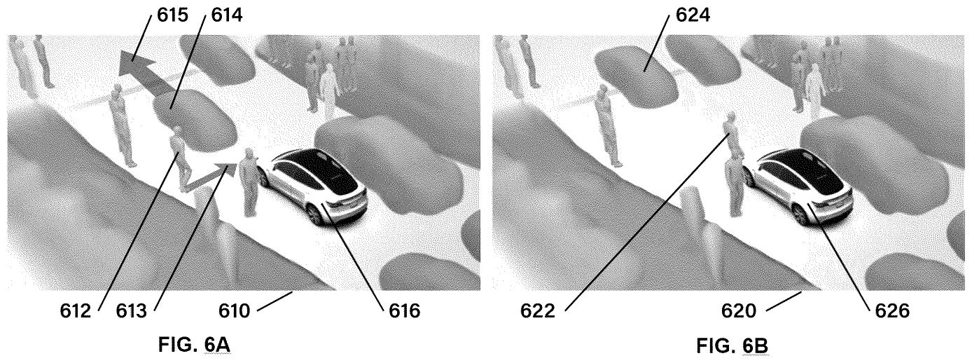

FIGS. 6A and 6B illustrate how moving objects are handled within the video frames of an actual remote scene 610 shown in FIG. 6A and the corresponding computer model remote scene 620 shown in FIG. 6B as shown on the operator's display. In the illustrated example, all people and cars in scene 610 are stationary, except person 612 and car 614. The cars and people in scene 610 are analyzed through object-recognition algorithms carried out on the remote equipment and categorized, including for example, the type of car, its geolocation, and its pose (i.e., orientation) as set forth previously. For all objects, this information is transmitted as part of the computer model remote scene 620 shown in FIG. 6B a single time to the remote operator's control unit, where the corresponding objects are stored and displayed to the remote operator as part of the model B in the correct geolocation (note that objects in the model B are numbered to be 10 greater than the corresponding real object in the sensed image of the actual remote scene 610 shown in FIG. 6A such that person 612 is numbered as 622 in the model, car 614 is numbered as 624 in the model, and car 616 is numbered as 626 in the model).

The velocity or velocity vector (magnitude (speed) and direction) of moving objects is sensed and/or derived by the remote equipment, such as person 612 and car 614, and also transmitted a single time to the remote operator's control unit, where that information is stored along with the associated object as part of the computer model remote scene 620 shown in FIG. 6B. The geolocation of moving objects is updated in the remote operator's display, based on their velocity vector that is stored as part of the model B so that the actual velocity need not be retransmitted.

The car 616 in scene 610 and car 626 in scene 620 is the remote equipment being controlled by the remote operator. As shown in scene 610, the person's velocity vector 613 and car's velocity vector 615 can also be shown on the operator's display.

If the velocity vector of a moving object changes as sensed by the remote equipment, then an updated velocity vector for the object is transmitted to the remote operator's control unit, where the stored velocity vector information for that associated object is updated for the model B. In one example, the velocity is vector of the computer model remote scene 620 shown in FIG. 6B is updated only if the sensed velocity magnitude (speed) or direction varies by more than a select amount as compared to the previously sensed/stored velocity, such as 2%, or 5% or 10%, or other amount.

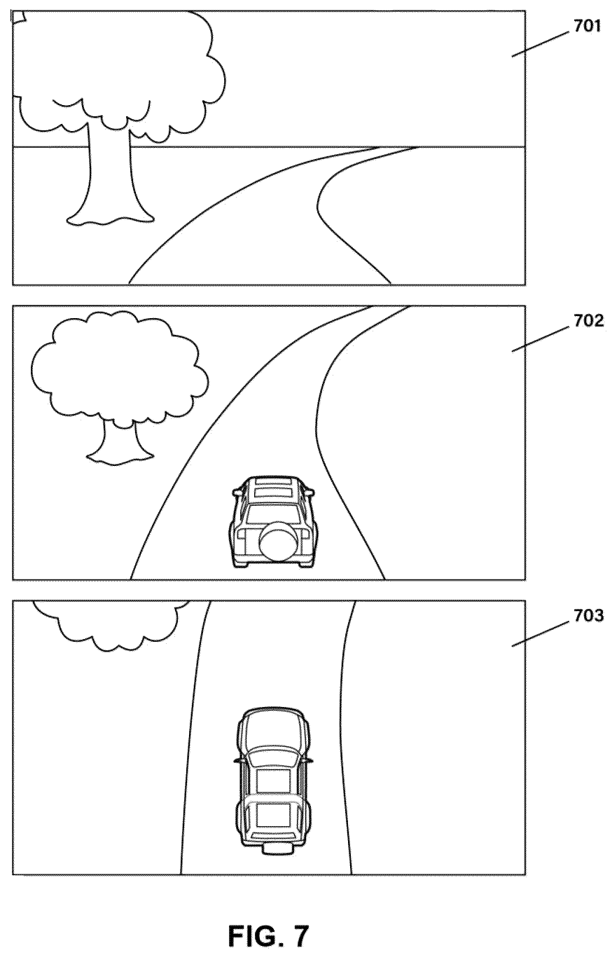

FIG. 7 shows how the remote scene can be displayed in a variety of view perspectives, which can be selected by the remote operator. A first display 701 shows the remote environment from the perspective of the remote vehicle's ‘driver's view’. Using the same data, a second display 702 shows the remote environment from an “over the shoulder” view perspective commonly used in video driving games. Again, using the same data, a third display 703 shows a top-down view perspective.

Because the terrain and objects are represented as stored data in a computer model of the remote scene, the remote operator's control unit can display a rendering of the terrain and objects from any arbitrary point of view.

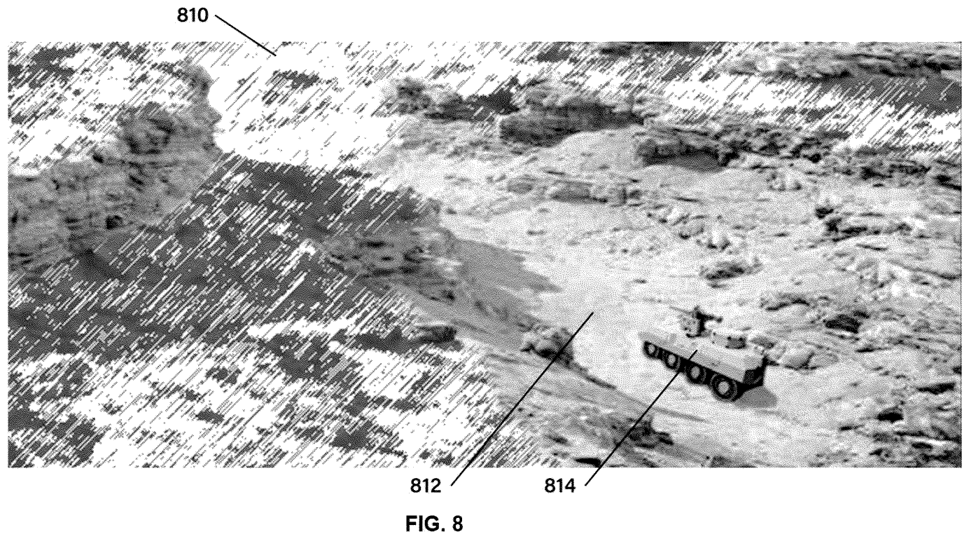

FIG. 8 illustrates how prior data from other sources can be combined with image data from the remote equipment to extend a scene 810 displayed to the remote operator. In the scene 810, the remote operator is controlling the movement of a vehicle 814 through remote terrain. A hashed portion 812 of the image of the scene 810 represents portions of the terrain that were not visible to sensors on the vehicle 814, but were stored on or otherwise available to the remote operator's control unit from previous imaging and terrain data and that were inserted into a mesh terrain model. The hashed portion 812 of the image can be displayed to the operator with a color overlay or some other visible difference indicia to indicate that the hashed portion 812 is not based on data from the remote equipment but is instead based upon stored data.

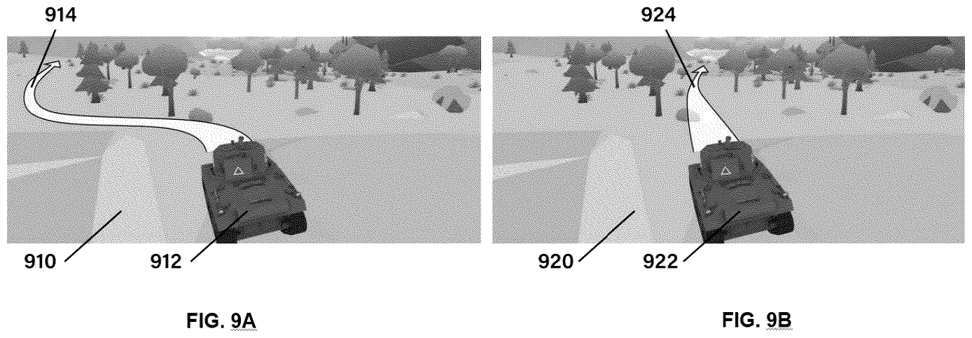

FIGS. 9A and 9B illustrate how a path plan generator by an autonomous movement system on remote equipment can be displayed to a remote operator as part of a model shown in FIG. 9A and how that operator can alter the path plan within the model shown in FIG. 9B. In a first scene 910 displayed to the remote operator as the model shown in FIG. 9A of a real-world scene, who is supervising movement of a tank 912 that has an on-board autonomy system, the intended autonomous path 914 is displayed to the operator as part of the model shown in FIG. 9A. A second scene 920 shows that the model is updated as shown at FIG. 9B so that the operator can command the autonomy system to change to new path 924 for the tank 922 as displayed to the operator.

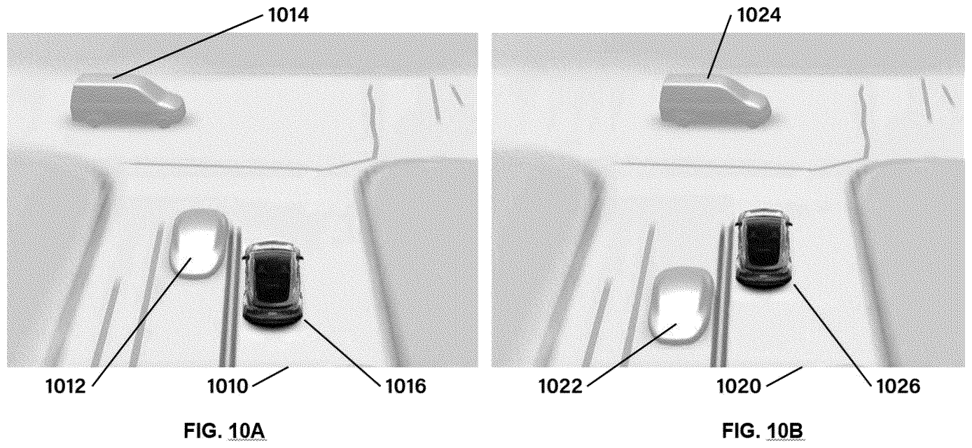

FIGS. 10A and 10B illustrate how the remote operator's control unit can compensate for latency. A first scene 1010 shows the location of a remote vehicle 1016, a car 1012, and a van 1014 within a model shown in FIG. 10A, based on when the data for these locations was transmitted from the remote equipment. Delays in transmission can cause latency that affects the ability of the operator to control the remote vehicle 1016.

A second scene 1020 shows that the model is updated as shown in FIG. 10B using each moving object's velocity vector to advance its geolocation to depict where these objects will be when the operator's control input arrives at the remote equipment. A remote vehicle 1026 has moved closer to the roadway intersection, while a car 1022 has moved further away from the roadway intersection. A van 1024 has entered the roadway intersection. The updated model shown in FIG. 10B is displayed to the remote operator and depicts the real-world conditions that are predicted to exist when the remote operator's control input arrives at the remote equipment. Advancing the geolocation on the operator's display of moving objects in the remote location based upon sensed velocity vectors allows the operator to more safely and precisely control the movement of remote equipment by visually compensating for latency.

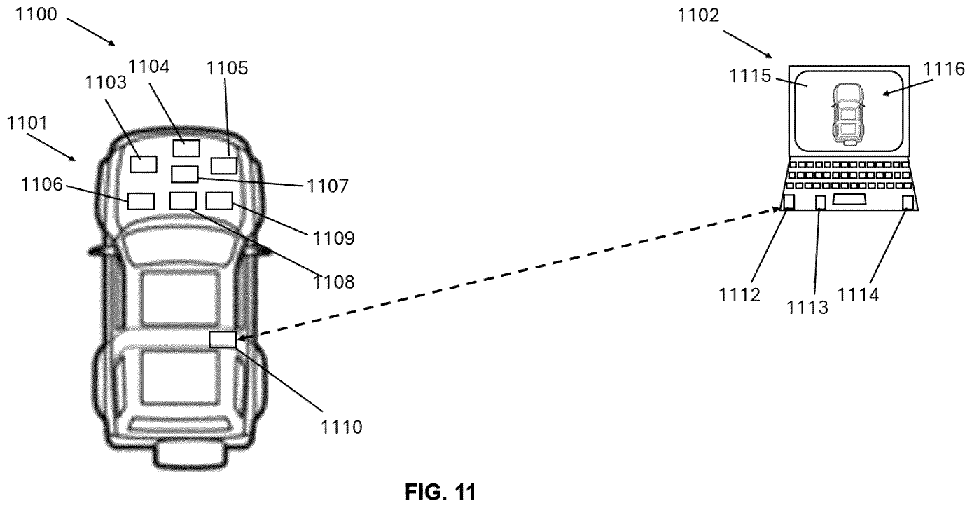

FIG. 11 shows components of a disclosed system 1100, including one or more sensors for use with a remote vehicle 1101, and a remote operator control station 1102 in electronic communication with the remote vehicle 1101. The system 1100 includes one or more sensors (each schematically depicted in FIG. 11 as a rectangle) disposed on a portion of the remote vehicle 1101 and configured to measure a parameter related to the remote vehicle 1101. For example, the one or more sensors can include an object detecting sensor 1103 configured to detect objects (i.e., trees) relative to the remote vehicle 1101. In another example, the one or more sensors can include an environmental lighting level sensor 1104 configured to detect an environmental light level of an area in which the remote vehicle 1101 is disposed. In another example, the one or more sensors can include a geolocation sensor 1105 configured to detect a position of the remote vehicle 1101 relative to the environment. The geolocation sensor 1105 can be implemented in a variety of manners (e.g., LIDAR sensors, stereo imaging sensors, GPS sensors, global navigation satellite system sensors, and so forth). In areas where satellite navigation is not available, the geolocation sensor 1105 can comprise a dead reckoning sensor (e.g., an IMU sensor, an odometry sensor, and so forth). In other examples, the geolocation sensor 1105 can comprise a landmark sensor configured to measure, for example, a bearing, a distance, and/or a triangulation to multiple landmarks relative to a position of the remote vehicle 1101. In some examples, the one or more sensors can include vehicle sensors 1106 configured to measure a parameter of the remote vehicle 1101 (e.g., a pose, a heading, a velocity (speed and direction), an acceleration, and so forth). Such vehicle sensors 1106 can include an IMU to measure pitch and roll angles, and/or acceleration, of the remote vehicle 1101, a MEMS IMU or a FOG to measure a heading angle of the remote vehicle 1101, and a speedometer to measure a speed of the remote vehicle 1101.

The system 1100 also includes at least one electronic processor 1107 (e.g., a microprocessor) configured to process data obtained by the sensor(s) 1103, 1104, 1105, 1106. In some examples, the electronic processor 1107 is configured to determine or estimate a trajectory of the remote vehicle 1101 from a combination of, for example, a speed and an acceleration of the remote vehicle 1101, along with commands transmitted to the remote vehicle for changes in steering speed (e.g., commanded by an autonomy system or commands from a remote operator operating the remote operator control station 1102.

In some embodiments, the sensor(s) can include a camera 1108 (e.g., a still camera, a video camera, and so forth), and the electronic processor 1107 is configured to process images acquired by the camera 1108, such as images acquired of objects relative to the remote vehicle 1101 and a terrain on which the remote vehicle 1101 is traveling. For example, the electronic processor 1107 is configured to implement object-detection and objection-recognition algorithms to detect and recognize objects (for example, trees) in images captured by the camera 1108. The electronic processor 1107 can compare the detected objects to a library of preassigned object subcategories, subtypes, and attributes. The electronic processor 1107 then assigns a unique identifier or code (for example, three digit codes for object category and subcategory, and two digit codes for attributes, or any other system of unique identifiers) to the detected/recognized objects in the images. The electronic processor 1107 can also estimate sizes and dimensions of the detected/recognized objects in the images. In addition, the electronic processor 1107 can also process data related to the remote vehicle 1101, such as updating the geolocation of the remote vehicle 1101 for moving objects when their geolocation is not otherwise consistent with what remote operator control station can calculate for those objects'trajectory based on previous known geolocations of the objects and time stamps and/or a current time. In addition, the electronic processor 1107 can also process data related to color and texture of the detected/recognized objects in the images. Moreover, the electronic processor 1107 can also process the images of the terrain acquired by the camera 1108 to create a mesh with areas of color and texture, and to process the created mesh to create simplified mathematical model describing, for example, a surface topology, a color, and/or a texture of the terrain.

The system 1100 can also include a clock 1109 used by the electronic processor 1107 to timestamp the acquired images and/or the processed data from the acquired images.

The system 1100 can also include a radio link 1110 to transmit data from the remote vehicle 1101 to the remote operator control station 1102. To do so, the electronic processor encodes the processed data (e.g., the unique identifier, the geolocation, the detected object category, the object subcategory and attributes, the detected terrain, the dimensions, the timestamps, the created mesh, and so forth) into a binary data stream. The maximum size of binary data stream is about 200 bits, which only needs to be sent to the remote operator control station 1102 a single time. The transmitted binary data can include, for example, new detected objects, new terrain features, an initial geolocation of the remote vehicle 1101, an initial environmental lighting level, initial position data of the remote vehicle 1101, initial trajectory data of the remote vehicle 1101, changes to the detected objects, changes to the detected terrain, changes to the geolocation of the remote vehicle 1101 that are not otherwise consistent with what remote operator control station 1102 can calculate from a previously-known geolocation and timestamp, a current time measured by the clock 1109, data about the remote vehicle 1101, and a trajectory of the remote vehicle 1101. The transmitted data can also include changes to environmental lighting level, changes to vehicle data, and changes to trajectory, among other possible data.

Turning to the remote operator control station 1102, the remote operator control station 1102 can be configured as any suitable electronic processing device, such as a laptop (as shown in FIG. 11), a smart laptop, a smartphone, a workstation computer, and so forth. The remote operator control station 1102 is configured to receive the data from the radio link 1110 disposed on the remote vehicle 1101 to a second radio link 1111 of the remote operator control station 1102, and stores the transmitted data in a memory 1112 (along with a library of image types, preexisting information about the terrain, sun and moon position of the terrain, and so forth). The remote operator control station 1102 also includes a clock 1113 to apply timestamps to the received data, and one or more electronic processors 1114 configured to process the received data (and to transmit data to the remote vehicle 1101).

The remote operator control station 1102 also includes a display device 1115 configured to display the acquired images and data from the remote vehicle 1101. The display device 1115 can display, for example, the terrain by processing the received model of the terrain, using preexisting terrain data to fill in any missing areas by allowing filled-in information to be distinguished by remote operator, for instance by coloring, and illuminating the terrain (e.g., using the environmental lighting level, sun and moon position to illuminate from correct lighting angle, and/or cast shadows from objects). The display device 1115 can display, for example, objects detected in the terrain by processing objects using stored received object data and library of image types, displaying objects in correct location (with an option to offset for moving objects), illuminating objects using the environmental lighting level. and/or the sun and moon position to illuminate from correct lighting angle.

The display device 1115 can also display, for example, a remote scene 1116 showing the remote vehicle 1101, with a trajectory of the remote vehicle 1101 as an optional overlay on the displayed scene. The display device 1115 can be adjusted by the remote operator to change the displayed scene 1116 (e.g., driver, overhead, behind/above, and so forth), or to update the display of the scene based on time. For example, the displayed scene 11116 on the display device 1115 can be updated based on movement of the remote vehicle 1101 (such as geolocation, position data, and trajectory), changes to the terrain, changes to the detected objects (i.e., moving objects), or to correct or update the displayed scene 1116 based on time, such as correcting the displayed scene for latency based on measured delay in the received vehicle time stamp, base d on an estimated movement of remote equipment, terrain, or objects (such as estimated location of moving objects). In some embodiments, the display device 1115 can display the displayed scene 1116 with augmented reality (AR) or virtual reality (VR) features overlaid onto the displayed scene 1116.

The remote operation control station 1102 can also be used to transmit commands from a remote operator to the remote vehicle 1101 (e.g., to adjust a speed or trajectory of the remote vehicle 1101). For example, the remote operator can use the remote operator control station 1102 to generate commands (i.e., “turn left”, “slow down”, and so forth), which are then transmitted to the radio link 1110 affixed to the remote vehicle 1101. The electronic processor 1107 then processes these commands to adjust operation of the remote vehicle 1101.

The disclosure has been described with reference to the preferred embodiments. Modifications and alterations will occur to others upon reading and understanding the preceding detailed description. It is intended that the disclosure be construed as including all such modifications and alterations.

What is claimed:

1. A method for tele-operation, said method comprising:
sensing image data of a remote environment using one or more sensors provided on remote equipment;
creating a simplified computer model of the remote environment by image processing carried out on the remote equipment;
transmitting the simplified computer model to a remote operator and displaying the simplified computer model to the remote operator.

2. The method as set forth in claim 1, wherein creating the computer model comprises recognizing an object in the image data and categorizing the recognized object as one of a plurality of different object types selected from a library stored on the remote equipment.

3. The method as set forth in claim 2, further comprising, for each said object, assigning said object to have at least one of: a subtype, a size, a geolocation, a color, a texture, details.

4. The method as set forth in claim 3, further comprising assigning each said object a unique sequence number for tracking.

5. The method as set forth in claim 4, wherein said object is categorized as a tree and wherein said object is further assigned at least one of: tree type, dimensions, geospatial location, shade of green, needle or leaf type, needle or leaf density, trunk diameter, and clear height between the ground and lower branches.

6. The method as set forth in claim 3, wherein, after said operation of transmitting the simplified computer model to the remote operator, updates to said model are transmitted to the remote operator without transmitting information about the model that is unchanged relative to a previously transmitted version of the model.

7. The method as set forth in claim 1, wherein terrain around the remote equipment is sensed using photogrammetry and/or simultaneous localization and mapping, and said method further comprises:
deriving a surface mesh that represents said terrain as part of said image processing carried out on said remote equipment;
transmitting said surface mesh to said remote operator as part of said model.

8. The method as set forth in claim 7, further comprising using pre-existing information about the terrain that is stored on the remote equipment and/or on the remote operator's control unit to fill in blind spots in the sensor data of the terrain as sensed by the remote equipment.

9. The method as set forth in claim 8, wherein the model displayed to the remote operator includes color or other indicia that indicates which part of said model is based upon said pre-existing information and which part of said model is based upon sensor data from the remote equipment such that a remote operator can determine which parts of said mesh model represent sensed data describing said terrain and which parts of said mesh model represent said pre-existing information.

10. The method as set forth in claim 7, wherein the remote equipment is using some level of autonomy to move within the remote environment, and wherein a future path of movement of the remote equipment is sent to the remote operator and displayed on the remote operator's control unit as part of the model, and wherein the remote operator can modify or cancel the intended autonomous movement and that control information is sent back to the remote equipment.

11. The method as set forth in claim 1 wherein at least one of:
the location and pose of the remote equipment that is being controlled is continuously tracked and sent the remote operator's control unit as part of the model;
terrain and objects in the remote environment are displayed to the remote operator as part of the model;
existing information about the terrain is stored on the remote operator's control unit and/or on the remote equipment and this data is used to fill in blind spots in the sensor data;
discrepancies between existing information and sensor data can be identified to the remote operator.

12. The method as set forth in claim 11, wherein a viewing angle and perspective displayed to the remote operator can be controlled by the remote operator.

13. The method as set forth in claim 1, wherein latency is estimated and the model of the environment displayed to the remote operator is adjusted forward in time to compensate for said latency.

14. The method as set forth in claim 13, wherein the remote equipment comprises an unmanned vehicle moving with a select velocity vector and a latency value is known or estimated, then a position of the unmanned vehicle can within the model is adjusted forward along a predicted path of the vehicle in the model image displayed to the operator.

15. A system comprising:
at least one sensor disposed on a portion of an associated remote vehicle, the at least one sensor configured to measure a corresponding parameter related to the associated remote vehicle; and
an operator control system configured to receive the measured corresponding parameter as a binary data stream of the associated remote vehicle, the binary data stream being on an order of hundreds of bits.

16. The system of claim 15, wherein a maximum size of the binary data stream is about 200 bits.

17. The system of claim 15, wherein the operator control system includes a display device configured to display the binary data stream including a scene of the associated remote vehicle and terrain in which the associated remote vehicle is disposed.

18. The system of claim 15, wherein the operator control system is configured to transmit commands to the associated remote vehicle to control operation of the associated remote vehicle.

19. The system of claim 15, wherein the at least one sensor includes one or more of:
an object detecting sensor;
an environmental lighting level sensor;
a geolocation sensor;
a vehicle sensor; and
a camera.

20. The system of claim 15, further comprising: the remote vehicle.
